(19) United States
(12) Patent Application Publication
(10) Pub. No.: US 2026/0236107 A1
(43) Pub. Date: Aug. 13, 2026

(54) PUSH BUTTON DEVICE AND ACOUSTIC DEVICE

(71) Applicant: AlphaTheta Corporation, Yokohama-shi, Kanagawa (JP)

(72) Inventors: Takeshi Hamamatsu, Yokohama-shi, Kanagawa (JP); Mitsuru Sugiyama, Yokohama-shi, Kanagawa (JP); Yutaka Hayashi, Yokohama-shi, Kanagawa (JP); Taito Fujioka, Yokohama-shi, Kanagawa (JP)

(21) Appl. No.: 19/138,155

(22) PCT Filed: Dec. 16, 2022
(86) PCT No.: PCT/JP2022/046515

§ 371 Date: Jun. 12, 2025

(51) Int. Cl. G06F 3/02; F21V 3/00; H01H 13/14; H01H 13/705

(52) U.S. Cl. CPC G06F 3/0202; H01H 13/14; H01H 13/705; H01H 13/83

(57) ABSTRACT

A push button device includes: a board including multiple press switches; multiple push buttons respectively associated with the multiple press switches; and connecting portions that each connect two adjacent ones of the multiple push buttons to each other. The multiple push buttons are disposed along a circumference around an axis along a direction from each of the push buttons to the board. The connecting portions each connect an end, of one of the push buttons, that is on a side of the axis to an end, of another one of the push buttons, that is on the side of the axis, and are each disposed to surround the axis.

### TECHNICAL FIELD

The invention relates to a push button device and an acoustic apparatus.

### BACKGROUND ART

A push button device has been used in various apparatuses. For example, Patent Literature 1 describes an operator including multiple buttons disposed circumferentially.

### CITATION LIST

### Patent Literature(s)

Patent Literature 1: JP 2011-138661 A

### SUMMARY OF THE INVENTION

### Problem(s) to be Solved by the Invention

In Patent Literature 1, operated parts are disposed at tips of hinge sections radially extended around a common base-end section. Such a configuration is useful for a space-saving purpose, for example; however, it can be difficult to maintain durability. In addition, if the durability is prioritized, an operational feeling can be deteriorated.

An object of the invention is to provide a push button device that achieves both durability and a favorable operational feeling, and an acoustic apparatus including the push button device.

### Means for Solving the Problem(s)

[1] A push button device includes: a board including multiple press switches; multiple push buttons respectively associated with the multiple press switches; and at least one connecting portion that connects two adjacent ones of the multiple push buttons to each other, in which the multiple push buttons are disposed along a circumference around an axis along a direction from each of the push buttons to the board, and the connecting portion connects an end, of one of the push buttons, that is on a side of the axis to an end, of another one of the push buttons, that is on the side of the axis, and is disposed to surround the axis.
[2] The push button device according to [1], further including at least one sleeve formed between each two adjacent ones of the push buttons.
[3] The push button device according to [2], in which the connecting portion and the sleeve are formed integrally with each other.
[4] The push button device the operation device according to [2] or [3], in which the sleeve has a light-shielding property.
[5] The push button device the operation device according to any one of [1] to [4], further including multiple illuminators respectively associated with the multiple press switches, in which all or a part of each of the push buttons has a light-transmitting property.
[6] An acoustic apparatus including the push button device according to any one of [1] to [5].

### BRIEF EXPLANATION OF DRAWING(S)

FIG. 1 is a schematic diagram illustrating an external configuration of a push button device according to an exemplary embodiment of the invention.

FIG. 2 is a perspective diagram illustrating a structure of the push button device according to an exemplary embodiment of the invention.

FIG. 3A is a schematic diagram illustrating a button section.

FIG. 3B is another schematic diagram illustrating the button section.

FIG. 4 is a schematic diagram illustrating a relationship between a board and the button section.

### DESCRIPTION OF EMBODIMENT(S)

Description will be made below on an exemplary embodiment of the invention with reference to the drawings attached.

### Structure of Push Button Device

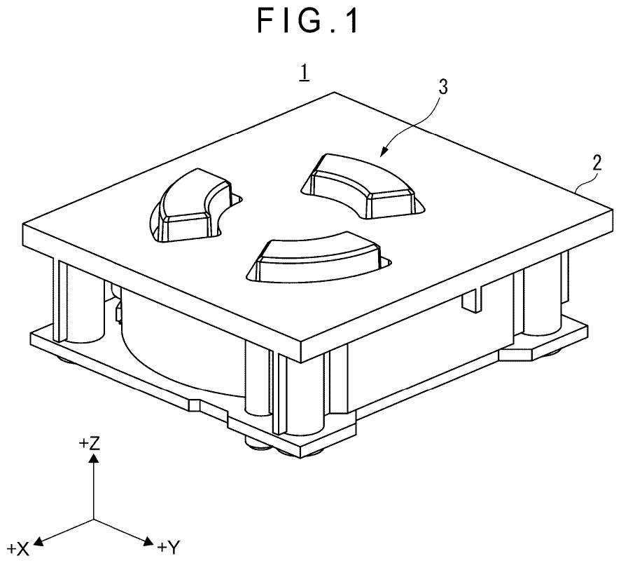

FIG. 1 is a schematic diagram illustrating an external configuration of a push button device 1 according to an exemplary embodiment.

As illustrated in FIG. 1, the push button device 1 includes a casing 2 and an operation unit 3. A part of the operation unit 3 is exposed from the casing 2. The push button device 1 accepts a user's operation of pressing the operation unit 3.

In the following description, three directions orthogonal to each other are defined as an X direction, a Y direction, and a Z direction. Of these, the Z direction is a vertical direction. The X direction and the Y direction are orthogonal to each other, and are each orthogonal to the vertical direction.

FIG. 1 illustrates an example of a device having only push buttons for purpose of explanation; however, the push button device 1 may be mounted and applied to any apparatuses. For example, the push button device 1 may be mounted and applied to acoustic apparatuses including DJ devices such as mixers or DJ controllers. The push button device 1 may also be similarly mounted and applied to various apparatuses other than the DJ devices, for example, various controllers and toys.

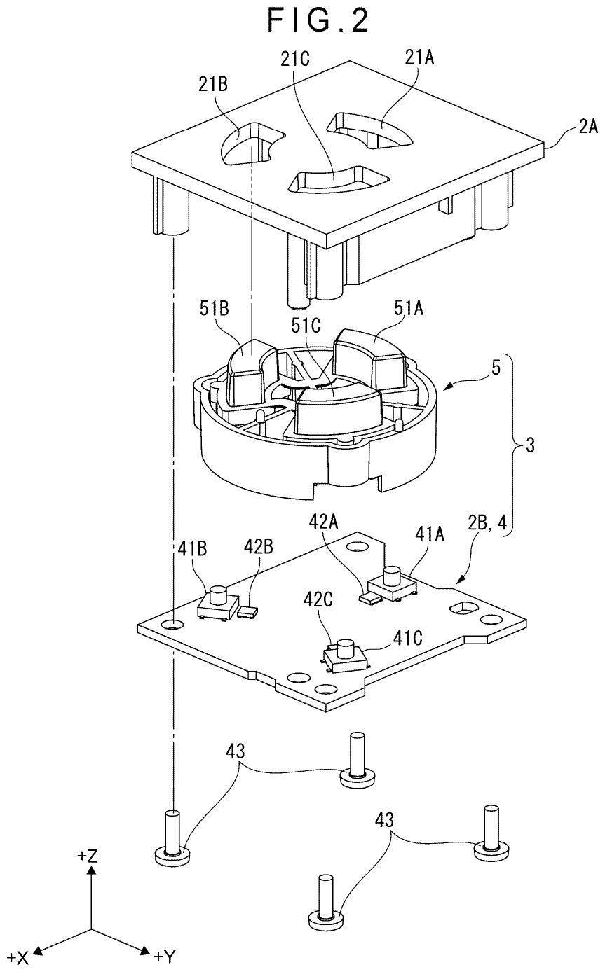

FIG. 2 is an exploded perspective diagram illustrating a structure of the push button device 1.

As illustrated in FIG. 2, the casing 2 includes an upper case 2A configuring an upper surface and a lower case 2B configuring a lower surface. The upper case 2A has openings 21A to 21C corresponding to the operation unit 3.

The operation unit 3 is disposed on a-Z side of the upper case 2A as illustrated in FIG. 2.

The operation unit 3 includes a board 4 and a button section 5. The board 4 serves as the lower case 2B of the casing 2. The button section 5 is adjacently disposed on the-Z side of the upper case 2A of the casing 2 and on a +Z side of the board 4. That is, the button section 5 is disposed so as to be sandwiched between the upper case 2A of the casing 2 and the board 4.

Disposed on the board 4 are, as illustrated in FIG. 2, three press switches 41A to 41C, and illuminators 42A to 42C respectively provided adjacently to the press switches 41A to 41C. The board 4 is engaged with the button section 5 and the upper case 2A with use of screws 43.

The press switches 41A to 41C may be configured by any switch, such as a tact switch or a membrane switch.

The illuminators 42A to 42C are each a light source for illumination using, for example, an LED device. The light source is not limited to the LED device.

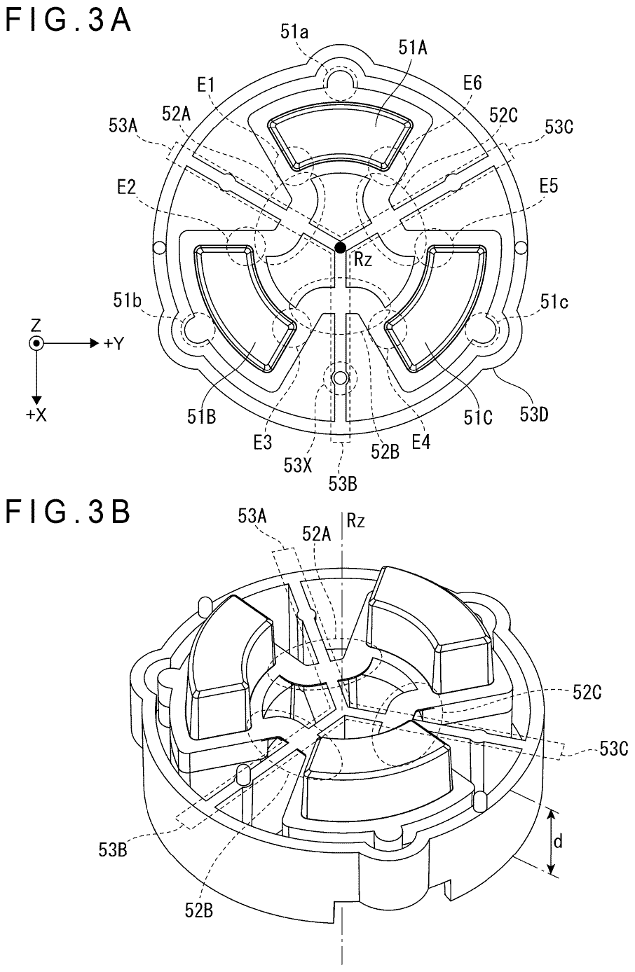

FIGS. 3A and 3B are each a schematic diagram illustrating the button section 5.

As illustrated in FIGS. 3A and 3B, the button section 5 includes push buttons 51A to 51C, connecting portions 52A to 52C, sleeves 53A to 53C, and an outer circumferential sleeve 53D. The push buttons 51A to 51C are respectively associated with the press switches 41A to 41C. The connecting portions 52A to 52C each connect two adjacent ones of the push buttons to each other. The sleeves 53A to 53C are each formed between the push buttons that are adjacent to each other.

As illustrated in FIGS. 3A and 3B, the push buttons 51A to 51C are disposed along a circumference around an axis along a direction from each of the push buttons to the board 4, i.e., a Z axis. Hereinafter, the center of the circumference is referred to as an axis Rz.

In addition, the push buttons 51A to 51C respectively have press portions 51a to 51c. The press portions 51a to 51c are respectively provided at positions corresponding to the press switches 41A to 41C of the board 4 described above. In addition, all or a part of each of the push buttons 51A to 51C, more specifically, a part, of each of the push buttons 51A to 51C, that is exposed from the casing 2 includes a material having a light-transmitting property.

As illustrated in FIGS. 3A and 3B, the connecting portions 52A to 52C each connect two adjacent ones of the push buttons to each other. That is, the connecting portion 52A connects two adjacent push buttons 51A and 51B to each other, the connecting portion 52B connects two adjacent push buttons 51B and 51C to each other, and the connecting portion 52C connects two adjacent push button 51C and 51A to each other.

Note that the connecting portions 52A to 52C each connect an end, of one of the push buttons 51A to 51C, that is on a side of the axis Rz to an end, of another one of the push buttons 51A to 51C, that is on the side of the axis Rz. The connecting portion 52A connects an end E1, of the push button 51A, that is on the side of the axis Rz and on a side of the push button 51B to an end E2, of the push button 51B, that is on the side of the axis Rz and on a side of the push button 51A. Similarly, the connecting portion 52B connects an end E3, of the push button 51B, that is on the side of the axis Rz and on a side of the push button 51C to an end E4, of the push button 51C, that is on the side of the axis Rz and on the side of the push button 51B. Further, the connecting portion 52C connects an end E5, of the push button 51C, that is on the side of the axis Rz and on the side of the push button 51A to an end E6, of the push button 51A, that is on the side of the axis Rz and on the side of the push button 51C.

As described above, the connecting portions 52A to 52C sequentially connects the push buttons 51A to 51C, and are thus disposed circumferentially so as to surround the axis Rz.

The push button 51A is connected to the two adjacent push buttons 51B and 51C on both sides of the push button 51A, with use of a pair of connecting portions 52A and 52C. The push button 51B is connected to the two adjacent push buttons 51C and 51A on both sides of the push button 51B, with use of a pair of connecting portions 52B and 52A. The push button 51C is connected to the two adjacent push buttons 51A and 51B on both sides of the push button 51C, with use of the pair of connecting portions 52C and 52B.

As illustrated in FIGS. 3A and 3B, the sleeves 53A to 53C are each formed between two adjacent ones of the push buttons, in a radial direction of a circle around the axis Rz. That is, the sleeve 53A is formed between the two adjacent push buttons 51A and 51B, the sleeve 53B is formed between the two adjacent push buttons 51B and 51C, and the sleeve 53C is formed between the two adjacent push button 51C and 51A.

Note that sleeves 53A to 53C are respectively formed integrally with the connecting portions 52A to 52C. The sleeve 53A is formed integrally with the connecting portion 52A. Similarly, the sleeve 53B is formed integrally with the connecting portion 52B. Further, the sleeve 53C is formed integrally with the connecting portion 52C.

Further, respective one ends of the sleeves 53A to 53C are formed so as to be integrated with each other at a position substantially coinciding with the axis Rz. In addition, the sleeves 53A to 53C each include a material having a light-shielding property.

In any of the sleeves 53A to 53C, a mechanism for preventing misidentification of an orientation in which the button section 5 is attached may be provided. For example, as illustrated in FIGS. 3A and 3B, a protrusion 53X is provided only on the sleeve 53B, and a recess is provided at a position, of the lower surface of the upper case 2A, that corresponds to the protrusion 53X, thereby restricting the orientation in which the button section 5 is attached, which prevents the misidentification of the orientation in which the button section 5 is attached. The protrusion 53X may be provided at a position other than the sleeve 53B, and multiple protrusions 53X may be provided.

As illustrated in FIGS. 3A and 3B, the outer circumferential sleeve 53D is formed circumferentially about the axis Rz so as to surround the push buttons 51A to 51C and the sleeves 53A to 53C.

Note that respective ends, of the sleeves 53A to 53C, that are on an opposite side to the axis Rz are formed so as to be integral with the outer circumferential sleeve 53D.

Further, the outer circumferential sleeve 53D may include a material having a light-shielding property, as with the sleeves 53A to 53C.

The connecting portions 52A to 52C are formed to be thin in the Z direction, as illustrated in FIG. 3B. In contrast, the sleeves 53A to 53C and the outer circumferential sleeve 53D each have a predetermined length d in the Z direction. The length d substantially corresponds to a distance between the upper case 2A of the casing 2 and the board 4.

Therefore, when the push buttons 51A to 51C are pressed in a-Z direction, the connecting portions 52A to 52C curve with the sleeves 53A to 53C as supports, which allows the connecting portions 52A to 52C to function as hinges. When the push button 51A is pressed in the-Z direction, the connecting portion 52A curves with the sleeve 53A as the support, and the connecting portion 52C curves with the sleeve 53C as the support. Similarly, when the push button 51B is pressed in the-Z direction, the connecting portion 52A curves with the sleeve 53A as the support, and the connecting portion 52B curves with the sleeve 53B as the support. Further, when the push button 51C is pressed in the-Z direction, the connecting portion 52B curves with the sleeve 53B as the support, and the connecting portion 52C curves with the sleeve 53C as the support.

When a middle of a push button is not pressed correctly, there have been issues that a twist in a hinge occurs, a risk of damage or deterioration of the hinge increases, and a loss of a force of pressing prevents the pressing force from being appropriately transmitted to a press switch or causes degradation in an operational feeling.

In contrast, in the push button device 1, two connecting portions that function as hinges are provided for each one push button, which increases a strength against the twist of the hinge. This makes it possible, even if a switch having a higher operating force (i.e., a heavy switch) is used, to achieve a favorable operational feeling without the hinge being damaged or deteriorated, and also to maintain durability. Further, two connecting portions that function as hinges are provided for each one push button. This makes it possible, even if one of the hinges is damaged or deteriorated, to maintain the function of the push button by the other hinge. It is therefore possible to expect a reduction in a risk caused by the damage or the deterioration of the hinge.

In addition, upon integral molding, there has been an issue of a weld line, which is a phenomenon of poor fusion that occurs at a junction point between resins. It is known that the weld line is likely to cause a decrease in strength.

In contrast, in the push button device 1, two connecting portions that function as hinges are provided for each one push button, which makes it is easy to avoid generation of the weld line even when the integral molding is to be performed.

Further, the sleeves 53A to 53C and the outer circumferential sleeve 53D each have a function as a light-shielding wall. For the push button 51A, the sleeves 53A and 53C and the outer circumferential sleeve 53D each function as the light-shielding wall, and light outputted from the illuminator 42A does not affect an outside of a partition of the push button 51A. Similarly, for the push button 51B, the sleeves 53B and 53C and the outer circumferential sleeve 53D each function as the light-shielding wall, and light outputted from the illuminator 42B does not affect an outside of a partition of the push button 51B. For the push button 51C, the sleeves 53B and 53C and the outer circumferential sleeve 53D each function as the light-shielding wall, and light outputted from the illuminator 42C does not affect an outside of a partition of the push button 51C.

It is therefore possible to efficiently dispose a self-illuminating button even in a space-saving environment. It is also possible to expect improvement in flexibility of a layout on a side of the board 4.

Further, as described above, the outer circumferential sleeve 53D is formed circumferentially about the axis Rz so as to surround the push buttons 51A to 51C and the sleeves 53A to 53C. The outer circumferential sleeve 53D also functions as a handle for supporting the button section 5 as a whole during an assembly work of the push button device 1. It is therefore also possible to expect a reduction in a shape defect such as warpage of the push button caused by direct touch to the push buttons 51A to 51C during the assembly work.

Referring back to FIG. 2, the upper case 2A of the casing 2 accommodates a part of the operation unit 3, more specifically, the push buttons 51A to 51C of the button section 5, from back sides of the openings 21A to 21C to thereby expose a part of each of the push buttons 51A to 51C on a front surface side. This makes it possible to operate the push buttons 51A to 51C from an outside.

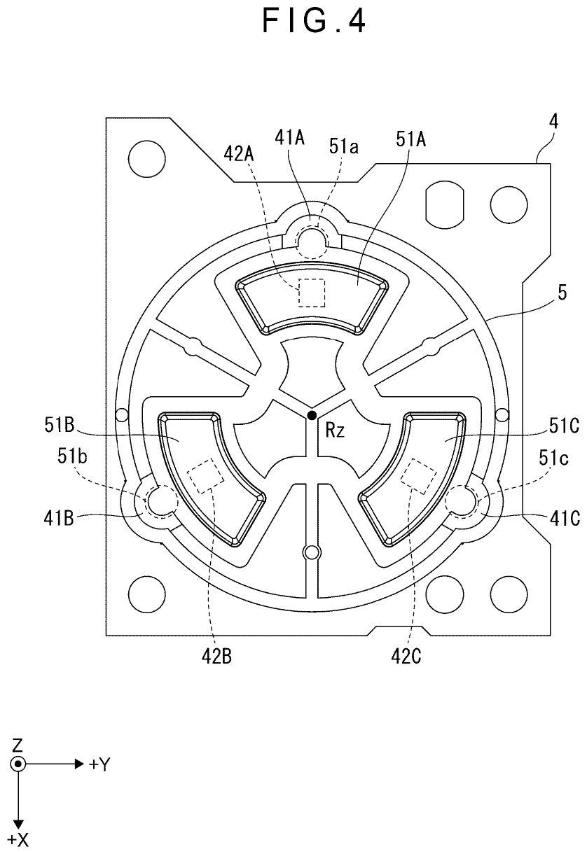

FIG. 4 is a schematic diagram illustrating a relationship between the board 4 and the button section 5.

As illustrated in FIG. 4, the push buttons 51A to 51C of the button section 5 are respectively superimposed above the illuminators 42A to 42C of the board 4, that is, in a +Z direction.

Accordingly, when the illuminators 42A to 42C output pieces of light, the pieces of light from the illuminators 42A to 42C are respectively led to bottom surface sides of the push buttons 51A to 51C. The respective parts, of the push buttons 51A to 51C, that are exposed from the casing 2 each have a light-transmitting property, which makes it possible, when the illuminators 42A to 42C output the pieces of light, to respectively illuminate the push buttons 51A to 51C from the bottom surface sides.

Further, the press portions 51a to 51c of the push buttons 51A to 51C are respectively superimposed above the press switches 41A to 41C of the board 4, that is, in the +Z direction. Accordingly, when the push button 51A is pressed in the −Z direction, the press portion 51a presses the press switch 41A on the board 4. Similarly, when the push button 51B is pressed in the −Z direction, the press portion 51b presses the press switch 41B on the board 4. Further, when the push button 51C is pressed in the −Z direction, the press portion 51c presses the press switch 41C on the board 4.

### Effects of Embodiment

It is possible for the push button device 1 according to the exemplary embodiment described above to achieve the following effects.

The push button device 1 includes: the board 4 including the multiple press switches 41A to 41C; the multiple push buttons 51A to 51C respectively associated with the multiple press switches 41A to 41C; and the connecting portions 52A to 52C that each connect two adjacent ones of the multiple push buttons 51A to 51C to each other. The multiple push buttons 51A to 51C are disposed along the circumference around the axis Rz along the direction from each of the push buttons 51A to 51C to the board 4. The connecting portions 52A to 52C each connect an end, of one of the push buttons 51A to 51C, that is on the side of the axis to an end, of another one of the push buttons 51A to 51C, that is on the side of the axis, and are disposed to surround the axis Rz.

With such a configuration, it is possible for the push button device 1 to achieve both durability and a favorable operational feeling. In particular, two connecting portions are provided for each one push button, which increases the strength against the twist of the connecting portion, and makes it possible to achieve both the durability and the favorable operational feeling without the connecting portion being damaged or deteriorated. Further, two connecting portions are provided for each one push button, which makes it possible to expect a reduction in a risk caused by the damage or the deterioration of the connecting portion.

In addition, upon integral molding, there has been an issue of a weld line, which is a phenomenon of poor fusion that occurs at a junction point between resins. It is known that the weld line is likely to cause a decrease in strength.

In contrast, in the push button device 1, two connecting portions are provided for each one push button, which makes it is easy to avoid generation of the weld line even when the integral molding is to be performed.

Further, the push button device 1 further includes the sleeves 53A to 53C each formed between two adjacent ones of the push buttons. Further, the connecting portions 52A to 52C are respectively formed integrally with the sleeves 53A to 53C. With such a configuration, the sleeves 53A to 53C function as hinges, which makes it possible to achieve both durability and a favorable operational feeling of each of the push buttons 51A to 51C.

Further, the sleeves 53A to 53C each have the light-shielding property, which allows each of the sleeves 53A to 53C to function as the light-shielding wall, and makes it possible to dispose a self-illuminating button efficiently and highly flexibly.

### Modification of Embodiments

The scope of the invention is not limited by the above exemplary embodiment but includes any modification and improvement as long as such modification and improvement are compatible with the invention.

The exemplary embodiment described above illustrates an example in which three press switches 41A to 41C and related parts are provided as multiple press switches; however, the number of the press switches and the related parts may be two, or three or more.

The exemplary embodiment described above illustrates an example in which two connecting portions are provided for each one push button; however, three or more connecting portions may be provided for each one push button.

Further, shapes and a layout of the sleeves 53A to 53C and the outer circumferential sleeve 53D described in the exemplary embodiment described above are merely an example, and are not limited to this example. For example, some or all of the sleeve 53A to 53C and the outer circumferential sleeve 53D may be absent. Further, an example has been described in which some or all of the sleeves 53A to 53C each have the axis Rz as one end and the outer circumferential sleeve 53D as another end; however, for example, some or all of the sleeves 53A to 53C may each have corresponding one of the connecting portions 52A to 52C as one end and the outer circumferential sleeve 53D as another end, that is, some or all of the sleeves 53A to 53C may have no sleeve in a peripheral part of the axis Rz. Further, for example, some or all of the sleeves 53A to 53C may each have corresponding one of the connecting portions 52A to 52C as one end and the axis Rz as another end, that is, no sleeve is provided between each of the connecting portions 52A to 52C and the outer circumferential sleeve 53D.

Suitable exemplary embodiments of the invention have been detailed above with reference to the attached drawings. However, the scope of the invention is not limited to the exemplary embodiments. It would be obvious for those skilled in the art to which the invention pertains that various modifications and revisions are conceivable within the technical idea described within claims, and it is understood that such modifications and revisions are naturally within the technical scope of the invention.

### EXPLANATION OF CODES

1: push button device, 2: casing, 2A: upper case, 2B: lower case, 3: operation unit, 4: board, 5: button section, 21A to 21C: opening, 41A to 41C: press switch, 42A to 42C: illuminator, 51A to 51C: push button, 52A to 52C: connecting portion, 53A to 53C: sleeve, 53D: outer circumferential sleeve

1. A push button device comprising:
a board including multiple press switches;
multiple push buttons respectively associated with the multiple press switches; and
at least one connecting portion that connects two adjacent ones of the multiple push buttons to each other, wherein
the multiple push buttons are disposed along a circumference around an axis along a direction from each of the push buttons to the board, and
the connecting portion connects an end, of one of the push buttons, that is on a side of the axis to an end, of another one of the push buttons, that is on the side of the axis, and is disposed to surround the axis.

2. The push button device according to claim 1, further comprising: at least one sleeve formed between each of the two adjacent ones of the push buttons.

3. The push button device according to claim 2, wherein the connecting portion and the sleeve are formed integrally with each other.

4. The push button device according to claim 2, wherein the sleeve has a light-shielding property.

5. The push button device according to claim 1, further comprising:
multiple illuminators respectively associated with the multiple press switches, wherein
all or a part of each of the push buttons has a light-transmitting property.

6. An acoustic apparatus comprising the push button device according to claim 1.
